(19) United States
(12) Patent Application Publication
(10) Pub. No.: US 2002/0118915 A1
(43) Pub. Date: Aug. 29, 2002

(54) Optical multiplexer/demultiplexer device

(76) Inventor: Stephen F. Sagan, Lexington, MA (US)

Correspondence Address: John E. Gunther, Digilens Inc, 615 Palomar Avenue, Sunnyvale, CA, 94086, US

(21) Appl. No.: 10/081,772

(22) Filed: Feb. 20, 2002

Related U.S. Application Data
(60) Provisional application No. 60/271,199, filed on Feb. 23, 2001.
(60) Provisional application No. 60/276,349, filed on Mar. 16, 2001.

(51) Int. Cl. G02B 6/28

(52) U.S. Cl. 385/24

(57) ABSTRACT

An optical multiplexer/demultiplexer device is comprised of a wedged integrator block, a broadband mirror, and an optical band-pass filter. Collimated light introduced into the integrator block propagates by means of reflection from the mirror and band-pass filter. At each reflection, a portion of the light is transmitted through the band-pass filter. Since the integrator block is wedged, the incidence angle of the light and the wavelength sub-band that is transmitted change at each reflection. Thus the device can demultiplex a single light beam into separate beams, each containing a different wavelength sub-band, and each exiting the integrator block at a different physical location. Alternative embodiments are disclosed including an optical multiplexer, an optical channel equalizer, and an optical channel routing switch.

This application claims priority to the following provisional applications: “Polarisation insensitive variable optical attenuator with multiple reflection wedge light guide multiplexer/demultiplexer,” Serial. No. 60/271,199, filed Feb. 23, 2001; and “Multiplexer/demultiplexer device using tilted thin film filter and wedge integrator,” Serial No. 60/276,349, filed Mar. 16, 2001.

### BACKGROUND OF THE INVENTION

This invention relates to an optical filtering device for use in optical telecommunications networks. Specifically, the present invention provides a means to multiplex or demulitplex the channels in a wavelength division mutliplexed optical telecommunications system.

Optical telecommunications networks make use of a technology entitled wavelength division multiplexing, in which multiple optical wavelengths are transmitted through a common optical fiber. Such networks have a need for multiplexer devices to combine the multiple wavelength signals into a single optical fiber, and for demultiplexer devices to separate the multiple wavelengths after transmission. Current optical multiplexer and demultiplexers are based on array waveguide gratings or free-space gratings in combination with one or more lens elements. Either approach is well suited to requirements with a large number of closely spaced wavelengths.

The present invention provides a compact, low cost optical multiplexer or demultiplexer suited for applications with a limited number of wavelengths or channels. The present invention is particularly suited for use in combination with a reflective attenuator array to form a channel power equalizer, in which case the same component can provide both the demultiplexing and multiplexing functions.

### SUMMARY OF THE INVENTION

The present invention provides a passive multiplexer/demultiplexer based on thin film filters and, in the preferred embodiment, a wedge shaped multiple reflection integrator block for application in optical telecommunications networks. The integrator block has two opposing surfaces that deviate from parallel by a small wedge angle. One of these surfaces is coated with a broadband reflector such as a gold film or a multilayer dielectric coating. The second surface has a multilayer filter coating that reflects all wavelengths in the band of interest except for a narrow wavelength sub-band that is transmitted. As is well known to those skilled in the art of optical design, the exact wavelength of the transmitted sub-band is determined by the design of the multilayer filter and by the incidence angle of the light.

In a first embodiment of the invention, collimated light introduced into the integrator block propagates by means of reflection from the two coated surfaces. Since the integrator block is wedged, the incidence angle of the light and the wavelength sub-band that is transmitted by the multilayer filter change at each reflection. Thus the device can demultiplex a single light beam into separate beams, each characterized by a different narrow wavelength band, and each exiting the integration block at a different physical location and at a slightly different angle.

In a second embodiment of the invention, collimated light beams of different wavelengths are introduced into the integrator block at different physical locations and slightly differing angles, propagate by means of reflection from the two coated surfaces, and exit the wedged integrator block as superimposed parallel beams. Thus the device can multiplex multiple wavelength channels into a single beam that can be coupled to an optical fiber.

In a third embodiment of the invention, collimated light introduced into the integrator block propagates by means of reflection from the two coated surfaces. Since the integrator block is wedged, the incidence angle of the light, and thus the wavelength sub-band that is transmitted by the multilayer filter, changes at each reflection. The light beams transmitted through the multilayer filter are reflected to a controlled extent by an array of variable optical attenuators, such that the power of each wavelength channel can be individually controlled. The reflected light beams are reintroduced into the integrator block and propagate by means of reflection from the two coated surfaces to exit the integrator block as a single beam suitable for coupling into an optical fiber

In a fourth embodiment of the invention, two of the multiplexer devices as described above are used to sandwich a reflective optical switch array, such that individual wavelength channels can be routed from one optical communications circuit to another.

### BRIEF DESCRIPTION OF THE DRAWINGS

FIG. 1 is a cross-sectional schematic illustration of the multiplexer/demultiplexer device of the present invention.

FIG. 2 is a detail view of an alternative design for the integrator block with multiple wedge angles.

FIG. 3 is a cross-sectional schematic illustration of a second embodiment of the present invention.

FIG. 4 is a cross-sectional schematic illustration of a third embodiment of the present invention.

FIG. 5 is a cross-sectional schematic illustration of a fourth embodiment of the present invention.

### DETAILED DESCRIPTION OF THE INVENTION

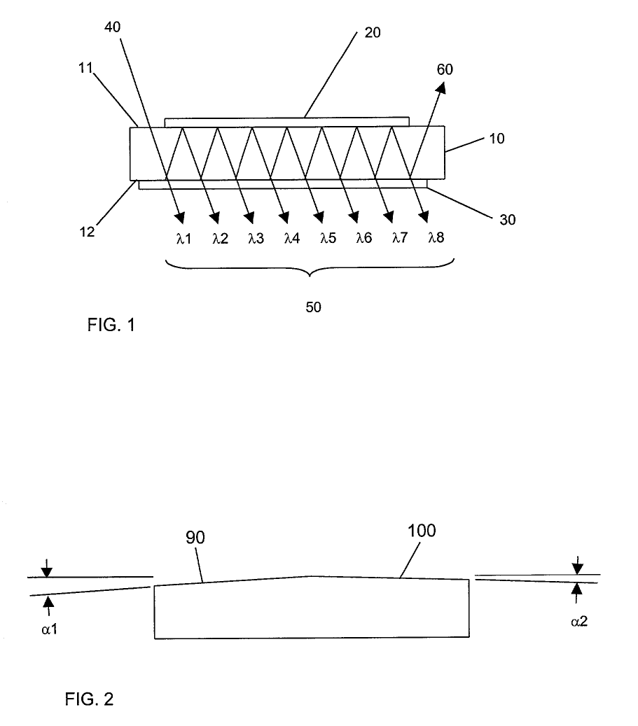

The basic principles of the invention can be understood by considering the eight channel optical demultiplexer shown in FIG. 1. The device comprises a broadband optical mirror 20, and an optical band-pass filter element 30. The broadband mirror element 20 and the band-pass filter element 30 are inclined at a small wedge angle with respect to each other. In the preferred embodiment, the invention also comprises a wedged glass multiple reflection block or integrator block 10, which serves to maintain the required alignment between the broadband mirror 20 and the band-pass filter 30.

In the preferred construction of the invention, the integrator block is fabricated with the top surface 11 and the bottom surface 12 inclined at a small wedge angle with respect to each other. Typically, the integrator block would be fabricated from a transparent material such as fused silica or optical glass (such as Schott BK7). The broadband mirror 20 is preferably a metallic film, such as gold, or a multilayer dielectric mirror deposited directly onto the top surface 11 of the integrator. Similarly, the optical band-pass filter 30 is preferably a multilayer dielectric filter deposited directly onto the lower surface 12 of the integrator. Alternately, the integrator 10, the broadband mirror 20, and the band-pass filter 30 could be separate elements assembled with the necessary wedge angle between the broadband mirror and the band-pass filter.

Referring again to FIG. 1, we now consider the operation of the optical demultiplexer. The input to the demultiplexer is a collimated light beam 40, comprising multiple communications channels at separate discrete wavelengths. The input beam 40 will typically be formed by means of a lens (not shown in FIG. 1) that collimates the light exiting an optical fiber. The input beam 40 enters the integrator 10 and strikes the band-pass filter 30 at a first angle such that light having wavelengths falling within a first pass-band is transmitted through the filter 30 as the output beam λ1. The wavelength components of input beam 40 that lie outside the first pass-band are reflected by band-pass filter 30 towards the top surface of the integrator. After reflection from the broadband mirror 20, the light beam is again incident on the band-pass filter 30. However, because of the small wedge angle between the mirror 20 and the band-pass filter 30, the incidence angle at the band-pass filter 30 is changed such that a second pass-band is transmitted to give the output beam λ2. The difference in wavelength between output beams λ1 and λ2 is determined by the change in incidence angle resulting from the integrator wedge angle. This wavelength shift is a well-known characteristic of thin film band-pass filters. It will be understood that as the process described above is repeated, a range of band passes (or optical channels) 50 will exit the integrator at different physical locations (and at slightly different angle). Light that does not fall within any of the pass-bands λ1-λ8 exits the integrator as output beam 60. This beam may be directed to additional demultiplexers as described above to provide more than eight channels.

The wavelength bandwidth of the output pass-bands λ1-λ8 is determined by the prescription of the multilayer band-pass filter 30. A well-known principle of multilayer optical band-pass filters is that the center wavelength is proportional to the cosine of the average beam propagation angle within the multilayer stack. The average angle with the multilayer stack is, in turn, determined by the optical design of the device and the average index of the filter. The average index of the filter is determined by the filter design and materials, and may range from 1.60 to 1.82 for practical filters. The wedge angle between the broadband mirror and the band-pass filter is determined by the desired wavelength spacing between the successive pass-bands and the average index of the band-pass filter. The wedge angle may range from about 4 arc minutes to about 16 arc minutes.

In a preferred embodiment of the demultiplexer, the band-pass filter 30 is a second-order Fabry Perot filter having a center wavelength of 1562.75 nm at normal incidence, a 3-dB pass-band width of 1.0 nm, and an average refractive index of 1.618. Such filters are commercially available from multiple sources including OptCom (San Jose, Calif.), Sonoma Photonics (Santa Rosa, Calif.), and Advanced Technology Coatings (Plymouth, United Kingdom). The integrator is constructed of fused silica glass and has a wedge angle of 13 arc minutes. The approximate size of the integrator is 25 mm long×10 mm wide×3.5 mm thick at the center of the wedge. The angle of the input beam 40 is 8.49 degrees (from the normal to the band-pass filter) within the integrator. For this example design, the angle at the lower surface of the integrator increases by twice the wedge angle, or 0.433 degrees at each successive incidence, resulting in a wavelength shift of 1.6 nm, on average, between the successive pass-bands λ1-λ8.

The pass-bands in this example design range from 1549.1 nm±0.5 nm for λ1 to 1537.9 nm±0.5 nm for λ8. These pass bands are centered (within ±0.2 nm) on eight wavelengths of the ICU grid spaced by 200 GHZ. The ICU grid is an international standard for the wavelengths used in wavelength division multiplexed optical communications networks.

As previously described, the center wavelength of the band-pass filter pass-band is proportional to the cosine of the average angle within the multilayer stack. Since the cosine function is not linear, uniform steps in the incidence angle at the band-pass filter will result in slightly non-uniform wavelength steps between the adjacent pass-bands. This inherent error in the channel-to-channel wavelength spacing accumulates as the number of channels is increased. A demultiplexer with a single wedge angle is limited to approximately eight channels.

The non-linear channel-to-channel wavelength spacing error can be reduced to a negligibly small value (typically less than ±0.05 nm) by arranging that the integrator is comprised of two or more regions with different wedge angles. An example of an integrator with two wedge angles α1 and α2 is shown in FIG. 2. In a further embodiment, the non-linear channel-to-channel wavelength spacing can be essentially eliminated if at least one of the top and bottom surfaces of the wedge has a continuously curved surface. A toroidal or cylindrical surface may be advantageous for this purpose.

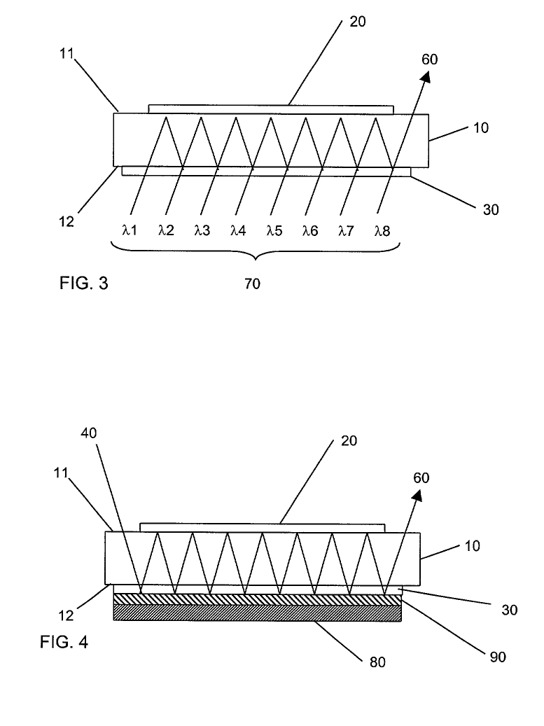

FIG. 3 shows an alternative embodiment in which the invention is used to combine, or multiplex, eight input beams 70, each having a different discrete wavelength λ1-λ8, into a common output beam 60. It can be readily understood that the function of this device is the inverse of that of the device illustrated in FIG. 1 and described previously. Since in the first embodiment the eight output beams have slightly different angles, the eight input beams of the second embodiment would need to have corresponding relative angular variations.

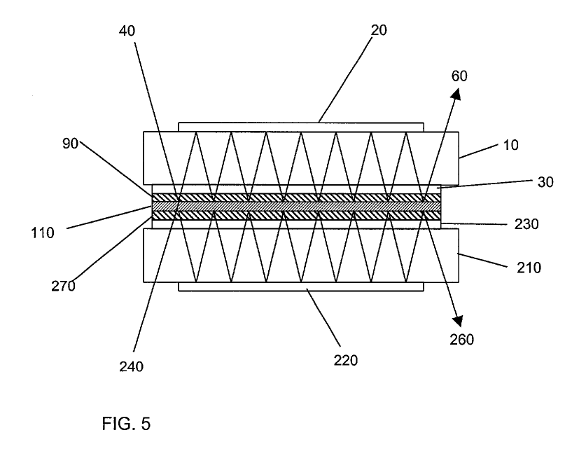

FIG. 4 shows a third embodiment of the invention in which the beams passing through the band-pass filter do not exit the device, but are reflected back into the integrator by means of a reflective optical device 80. The individual beams then propagate by multiple reflections within the integrator until they exit in the output beam 60. The reflective optical device 80 will typically be an array of optical attenuators that can be used to adjust the power of each pass band individually. Such a device is useful to equalize the power of the multiple channels in a wavelength division multiplex optical communications network. Micro-electro-mechanical (MEMs) attenuators could be used to reflect a controlled portion of the power within each pass band. Alternately, the reflective optical device 80 could be an array of polarization insensitive electrically switchable Bragg grating variable optical attenuators, such as that described in a co pending U.S. patent application assigned to the assignee of the present invention. The reflective optical device could perform some other function other than attenuation, such as changing the polarization state of the light, for example.

It is a well-known characteristic of multilayer optical band-pass filters that the filter pass band is dependent on the polarization state of the incident light. This dependence, although small for the incidence angles deployed in the present invention, is exacerbated in the embodiment of FIG. 4, since the light passes through the filter twice. To minimize the polarization dependence, a one-quarter-wave retardation plate 90 can optionally be disposed between the band-pass filter and the reflective optical device.

FIG. 5 shows an alternative embodiment in which a demultiplexer, comprised of integrator 10, broadband mirror 20, and band-pass filter 30 is used in conjunction with a multiplexer comprised of integrator 210, broadband mirror 220, and band-pass filter 230. Both the multiplexer and demultiplexer are previously described embodiments of the present invention. The multiplexer and demultiplexer are configured back to back and separated by an optical device 110, such as an array of electrically switchable Bragg gratings, that can be switched between reflective and transparent states.

Electrically switchable Bragg gratings are well-known optical components formed by recording a Bragg grating (also commonly termed a volume phase grating or hologram) in a polymer dispersed liquid crystal (PDLC) mixture. The resulting volume phase (Bragg) grating can exhibit very high diffraction efficiency, which may be controlled by the magnitude of the electric field applied across the PDLC layer. U.S. Pat. No. 5,942,157 by Sutherland et al. and U.S. Pat. No. 5,751,452 by Tanaka et al. describe monomer and liquid crystal material combinations and processes for fabricating switchable reflective optical devices suitable for use in this embodiment of the present invention.

Input beam 40 is comprised of multiple optical channels, each with a discrete wavelength. At the first incidence on the band pass filter 30, a first pass band is transmitted through the band-pass filter 30 to the optical device 110. If the optical device 110 is in its reflective state, the light will be reflected back through filter 30 into the integrator 10. After multiple reflections within integrator 10, the light will exit the device as part of the output beam 60. However, if the optical device 110 is in its transparent state, the light will transmit through band-pass filter 230 into integrator 210. After multiple reflections within integrator 210, the light will exit the device as part of output beam 260. Each of the channels can be routed into either output beam 60 or output beam 260 independently. Such a device could be used as a multiple channel add/drop switch for optical telecommunications applications.

The polarization dependence of the embodiment of FIG. 5 can be minimized by optionally placing a one-quarter-wave retardation plate 90 between the band-pass filter 30 and the optical device 110, and a second one-quarter-wave retardation plated 270 between the optical device 110 and the second band-pass-filter 230.

While the previously described embodiments of the invention were limited to eight wavelength pass bands or channels, it should be understood that it is possible to cascade two or more devices in series to increase the effective number of channels. Alternatively, optical interleavers could be employed to distribute a number of channels among two or more devices.

The various embodiments have been described in their most basic form. Practical implementations may include additional optical elements such as collimating lenses or lens arrays, relay lenses, optical coatings, and optical means for eliminating stray light from the beam propagation path.

What is claimed is:

1. An optical multiplexer/demultiplexer device comprising:
a broadband mirror having a first reflective surface, and
an optical band pass filter having a second reflective surface, disposed adjacent to said broadband mirror with said second reflective surface facing said first reflective surface,
wherein the space between said first and second reflective surfaces is filled with an optically transmissive media, and
wherein, said first and second surfaces deviate from parallel by a small angle;
a broadband mirror disposed on said first surface; and
an optical band-pass filter disposed on said second surface.

2. The device of claim 1 wherein said optically transmissive media is a glass or fused silica integrator block.

3. The device of claim 1 wherein said first and second surfaces are both planar surfaces that deviate from parallel by a first wedge angle.

4. The device of claim 3 wherein said first wedge angle is between about 4 arc minutes and about 16 arc minutes.

5. The device of claim 3 wherein said broadband mirror has a third planar surface contiguous with said first surface, and said third surface deviating from parallel to said second surface by a second wedge angle differing from said first wedge angle.

6. The device of claim 5 wherein said first wedge angle and said second wedge angle are between about 4 arc minutes and about 16 arc minutes.

7. The device of claim 1 wherein at least one of said first surface and said second surface is a non-planar surface such that the angle between said first surface and said second surface varies within a range between about 4 arc minutes and about 16 arc minutes.

8. The device of claim 1 further comprising a reflective optical device disposed adjacent to said optical band-pass filter.

9. The device of claim 8 wherein said reflective optical device comprises an array of at least two micro-electro-mechanical optical attenuators.

10. The device of claim 8 wherein said reflective optical device comprises an array of at least two electrically switchable Bragg grating attenuators.

11. The device of claim 8 wherein said reflective optical device comprises an array of at least two optical switches, which can be switched between a reflective mirror state and a transparent state.

12. The device of claim 8 further comprising a one-quarter-wave retardation plate disposed between said optical band-pass filter and said reflective optical device.
